(19) United States
(12) Patent Application Publication
(10) Pub. No.: US 2013/0016182 A1
(43) Pub. Date: Jan. 17, 2013

(54) COMMUNICATING AND PROCESSING 3D VIDEO

(71) Applicants: Robert C. Booth, Ivyland, PA (US); Dinkar N. Bhat, Princeton, NJ (US); Patrick J. Leary, Horsham, PA (US)

(72) Inventors: Robert C. Booth, Ivyland, PA (US); Dinkar N. Bhat, Princeton, NJ (US); Patrick J. Leary, Horsham, PA (US)

(73) Assignee: GENERAL INSTRUMENT CORPORATION, Horsham, PA (US)

(21) Appl. No.: 13/181,535

(22) Filed: Jul. 13, 2011

(51) Int. Cl. H04N 13/02

(52) U.S. Cl. 348/46; 348/E13.074

(57) ABSTRACT

There is a communicating of 3D video having associated metadata. The communicating may involve devices and includes receiving a first video bitstream with the 3D video encoded in a first format, receiving the associated metadata. The communicating also includes forming a protocol message, utilizing a processor, including the associated metadata. The communicating also includes transmitting a second video bitstream with the 3D video encoded in a second format and transmitting the protocol message separate from the second video bitstream. The protocol message includes data fields holding processing data, based on the associated metadata, describing the rendering of the 3D video. The processing data is operable to be read and utilized to direct a client device to process the 3D video extracted from a video bitstream and present the 3D video on a display. Also, there is a processing of the 3D video. The processing utilizes the protocol message.

### BACKGROUND

Depth perception for three dimensional (3D) video, also called stereoscopic video, is often provided through video compression by capturing two related but different views, one for the left eye and another for the right eye. The two views are compressed in an encoding process and sent over various networks or stored on storage media. A decoder, such as a set top box or other device, decodes the compressed 3D video into two views and then outputs the decoded 3D video for presentation. A variety of formats are commonly used to encode or decode and then present the two views in a 3D video.

Many video decoders and/or client devices require that a received video bitstream from an upstream source, such as a headend, be transcoded before the video bitstream may be decoded or utilized. Video transcoding is also utilized to convert incompatible or obsolete encoded video to a better supported or more modern format. This is often true for client devices which are capable of rendering 3D video and/or for client devices having only a two dimensional (2D) video presentation capability. Mobile devices often have smaller sized viewing screens, less available memory, slower bandwidth rates among other constraints. Video transcoding is commonly used to adapt encoded video to these constraints commonly associated with mobile phones and other portable Internet-enabled devices.

However many client devices, and especially mobile devices, often cannot effectively process 3D video encoded in a video bitstream. This is because many of these devices are not capable of accessing or extracting sufficient information from a received video bitstream regarding the 3D video for 3D rendering and/or 3D presentation. In addition, even for client devices having 3D rendering and presentation capabilities, there is no established standard for coding information in a video bitstream regarding 3D rendering and/or 3D presentation. Furthermore, various client devices do not follow all established standards and are not required to do so.

For all these reasons, many client devices are not able to address how an encoded 3D video in a video bitstream is to be rendered and presented for viewing. Instead, when receiving such a video bitstream with 3D video, the client devices often present anomalies associated with the 3D video on the viewing screen. An example of a common anomaly in this situation is a split screen of the two views in the 3D video. There are often other less attractive renderings of the 3D video in the video bitstream, or it may not be viewable at all through a client device. The users of these client devices are thus deprived of a satisfying experience when viewing 3D video on these client devices.

### SUMMARY OF THE INVENTION

According to a first embodiment, there is a receiver apparatus communicating 3D video having associated metadata. The receiver apparatus includes an input terminal configured to receive a first video bitstream with the 3D video encoded in a first format, and to receive the associated metadata. The receiver apparatus also includes a processor configured to form a protocol message, utilizing the associated metadata. The receiver apparatus also includes an output terminal configured to signal a second video bitstream with the 3D video encoded in a second format, and signal the protocol message.

According to a second embodiment, there is a method of communicating 3D video having associated metadata. The method includes receiving a first video bitstream with the 3D video encoded in a first format and receiving the associated metadata. The method also includes forming a protocol message, utilizing a processor, including the associated metadata. The method also includes signaling a second video bitstream with the 3D video encoded in a second format and signaling the protocol message.

According to a third embodiment, there is a non-transitory computer readable medium (CRM) storing computer readable instructions that when executed by a computer system perform a method of communicating 3D video having associated metadata. The method includes receiving a first video bitstream with the 3D video encoded in a first format and receiving the associated metadata. The method also includes forming a protocol message, utilizing a processor, including the associated metadata. The method also includes signaling a second video bitstream with the 3D video encoded in a second format and signaling the protocol message.

According to a fourth embodiment, there is a client device to process 3D video having associated metadata. The client device includes an input terminal configured to receive a protocol message including the associated metadata, and to receive a video bitstream with the 3D video encoded in a format conforming with a definition in the received protocol message. The client device also includes a processor configured to extract the associated metadata from the received protocol message, and to process the 3D video from the received video bitstream utilizing the associated metadata extracted from the protocol message.

According to a fifth embodiment, there is a method of processing a 3D video having associated metadata. The method includes receiving a protocol message including the associated metadata and receiving a video bitstream with the 3D video encoded in a format conforming with a definition in the received protocol message. The method also includes extracting, utilizing a processor, the associated metadata from the received protocol message and processing the 3D video from the received video bitstream utilizing the associated metadata extracted from the protocol message.

According to a sixth embodiment, there is a non-transitory computer readable medium (CRM) storing computer readable instructions that when executed by a computer system perform a method of processing a 3D video having associated metadata. The method includes receiving a protocol message including the associated metadata and receiving a video bitstream with the 3D video encoded in a format conforming with a definition in the received protocol message. The method also includes extracting, utilizing a processor, the associated metadata from the received protocol message and processing the 3D video from the received video bitstream utilizing the associated metadata extracted from the protocol message.

The examples present a way for communicating and processing 3D video with respect to a client device. The communication and/or processing is such that the 3D video may be rendered and/or presented on a client device. The client devices may be those which otherwise could not render and/or present the 3D video, either as 3D video or as 2D video, when receiving a video bitstream with the encoded 3D video. According to the examples, the client devices do not present anomalies, such as a split screen of the two views in the 3D video, and/or other less attractive renderings of the 3D video in the video bitstream. Users of the client devices are thus provided with a satisfying experience when viewing the 3D video on the client device.

### BRIEF DESCRIPTION OF THE DRAWINGS

Features of the present disclosure will become apparent to those skilled in the art from the following description with reference to the figures, in which:

FIG. 1 is a system context diagram illustrating a system, according to an example of the present disclosure;

FIG. 2 is a block diagram illustrating a receiver apparatus operable with the system shown in FIG. 1, according to an example of the present disclosure;

FIG. 3 is a block diagram illustrating a client device operable with the system shown in FIG. 1, according to an example of the present disclosure;

FIG. 4 is a flow diagram illustrating a communicating method operable with the receiver apparatus shown in FIG. 2, according to an example of the present disclosure;

FIG. 5 is a flow diagram illustrating a processing method operable with the client device shown in FIG. 3, according to an example of the present disclosure; and

FIG. 6 is a block diagram illustrating a computer system to provide a platform for the receiver apparatus shown in FIG. 2 and/or the client device shown in FIG. 3 according to examples of the present disclosure.

### DETAILED DESCRIPTION

For simplicity and illustrative purposes, the present disclosure is described by referring mainly to examples thereof. In the following description, numerous specific details are set forth in order to provide a thorough understanding of the present disclosure. It is readily apparent however, that the present disclosure may be practiced without limitation to these specific details. In other instances, some methods and structures have not been described in detail so as not to unnecessarily obscure the present disclosure. Furthermore, different examples are described below. The examples may be used or performed together in different combinations. As used herein, the term “includes” means includes but not limited to the term “including”. The term “based on” means based at least in part on.

According to examples of the disclosure, there are methods, receiving apparatuses and computer-readable media (CRMs) for communicating 3D video and methods, client devices and CRMs for processing 3D video. The examples present a way for communicating and processing 3D video with respect to a client device. The communication and/or processing is such that the 3D video may be rendered and/or presented on a client device. The client devices may be those which otherwise could not render and/or present the 3D video, either as 3D video or as 2D video, when receiving a video bitstream with the encoded 3D video. According to the examples, the client devices do not present anomalies, such as a split screen of the two views in the 3D video, and/or other less attractive renderings of the 3D video in the video bitstream. Users of the client devices are thus provided with a satisfying experience when viewing the 3D video on the client device.

The present disclosure demonstrates a system including a receiver apparatus and client device. According to an example, the receiver apparatus communicates a protocol message to the client device. The client device utilizes the received protocol message in processing encoded 3D video in a video bitstream delivered to the client device. Utilizing the protocol message, the client device may render and/or present the 3D video for viewing through the client device.

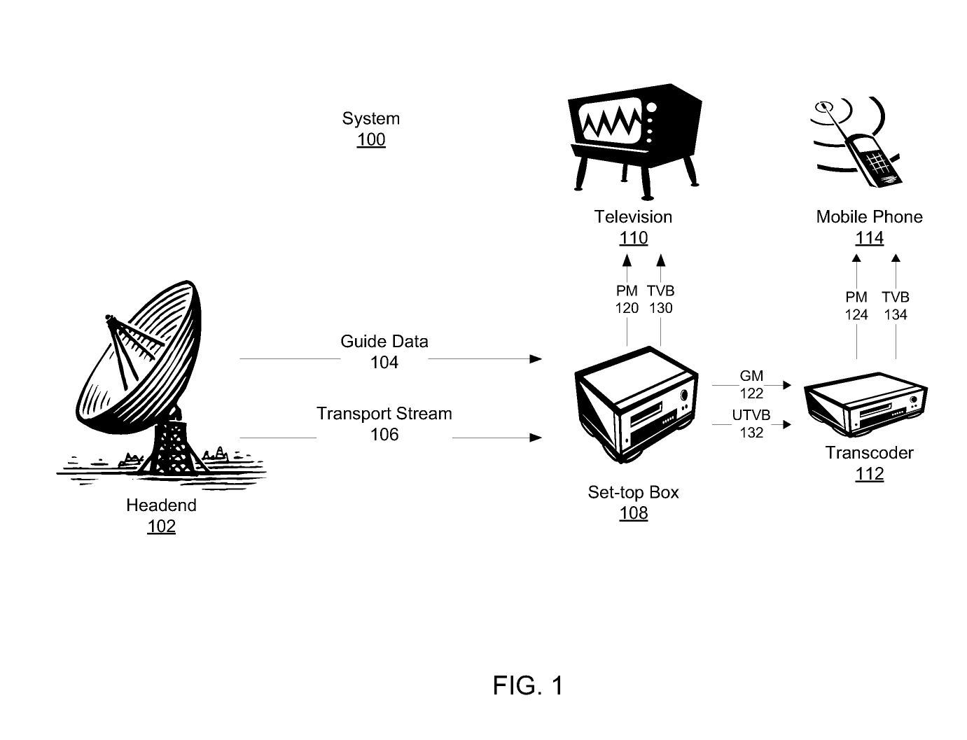

Referring to FIG. 1, there is shown a system 100 including a headend 102. The headend 102 transmits guide data 104 and a transport stream 106 to a receiver apparatus, such as set top box 108. A transport stream may include a video bitstream with encoded 3D video and/or 2D video. Transport stream 106 may include encoded 3D video in a compressed video bitstream.

The transport stream 106 may also include associated metadata for the encoded 3D video (i.e., metadata associated with the 3D video is “associated metadata”.) Associated metadata includes information connected with, related to, or describing the 3D video. Metadata may be “associated metadata” regardless as to whether the associated metadata is encoded in packets associated with the encoded 3D video, or included in separate messages in the transport stream 106, or received from another source, such as a storage associated with a database separate from the headend 102. The associated metadata may include information describing various aspects of the encoded 3D video. The various aspects described in the associated metadata may include video type, encoding format, program name, content producer, color range, definition level, 3D flagging and/or other information and parameters. These other information and parameters may include those operable to be utilized at a client device in rendering and presenting the 3D video associated with the encoded 3D video at the client devices.

Guide data 104 may include a subset of “associated metadata”. The guide data 104 may be associated with the encoded 3D video in the transport stream 106. The guide data 104 may also be provided from electronic program guides and/or interactive program guides which are produced by content service providers. Guide data 104 may be associated with content distributed from the headend 102, such as television programs, movies, etc. The distributed content may include the encoded 3D video. Guide data 104 may also include information describing various aspects of the encoded 3D video. The various aspects may include video type, encoding format, program name, content producer, color range, definition level, 3D flagging and/or other information and parameters. These other information and parameters may include those operable to be utilized at a client device in rendering and presenting encoded 3D video at the client devices. The guide data 104 may be transmitted from the headend 102 in a separate information stream, as depicted in FIG. 1. Guide data 104 may also be included in a transport stream, such as transport stream 106.

The associated metadata and/or guide data 104 may be incorporated into a protocol message, such as protocol message 120 and protocol message 124 depicted in FIG. 1. The protocol message may be formed at the receiver apparatus, such as the set-top box 108 according to an example, or at some other device which may transmit the protocol message to a client device. The protocol message may be prepared in a programming language such as XML and/or the coding may be proprietary. In forming the protocol message the receiver apparatus may derive information about the 3D video in the compressed video bitstream received at the receiver apparatus. The protocol message may incorporate this derived information about the 3D video to populate data fields in the protocol message with 3D video processing data. The derived information may also be utilized to construct scripts or programming commands which are included in the protocol message to be executed at the client device. The protocol message may subsequently be received at a client device which also receives a video bitstream including encoded 3D video. The client device may then utilize the 3D video processing data and/or scripts or programming commands in the protocol message to process the 3D video at the client device.

System 100 in FIG. 1 includes the set top box 108 which may operate as a receiver apparatus, according to an example. The set top box 108 may transmit a protocol message (PM) 120 with a transcoded video bitstream (TVB) 130 to a television 110. The set top box 108 may transmit the transcoded video bitstream 130 to the television 110, separate from or combined with the protocol message 120. In one example, the television 110 is a client device and may utilize the protocol message 120 to process encoded 3D video in the transcoded video bitstream 130 received at television 110.

According to different examples, a client device, such as television 110 may have 3D video presentation capabilities or be limited to having 2D video presentation capabilities. In both examples, the television 110 may utilize the protocol message 120 to process the 3D video in TVB 130 in different ways. If the television 110 has 3D video presentation capabilities, it may utilize the processing data and/or programming commands in the protocol message 120 to render the 3D video to present a stereoscopic view according to a 3D viewing mode. If the television 110 has 2D video presentation capabilities, it may utilize the processing data and/or programming commands in the protocol message 120 to render the 3D video for presentation in a 2D view according to a 2D viewing mode. In addition, the protocol commands may be processed at the television 110 to instruct the 2D presentation to address any anomalies which may arise from presenting 3D video in a 2D viewing mode. According to an example, the protocol commands may be operable to address a split screen presentation of the two views in the 3D video by stretching a single view to cover the entire viewing screen.

Transcoding units may be utilized in system 100 in various and non-limiting ways, according to different examples. The set-top box 108, as a receiving apparatus, may include an integrated transcoder which transcodes an untranscoded video bitstream (UTVB) 132 received at the set-top box 108 in the transport stream 106 to form TVB 130. In another example, the set top box 108 receives the UTVB 132 as first video bitstream and transmits it as UTVB 132 to a separate transcoder, such as transcoder 112. Transcoder 112 receives UTVB 132 transmitted from the set top box 108.

According to an example, the set top box 108 may include an integrated transcoder which may or may not change the encoding format of the UTVB 132 received with transport stream 106. According to another example, the set-top box 108 may construct a guide data message 122 to transmit to the transcoder 112 with UTVB 132. The guide data message 122 includes information, such as associated metadata or guide data 104 about the encoded 3D video in the UTVB 132. In this example, the guide data message 122 is received at the transcoder 112 which forms a protocol message 124 by deriving 3D video processing data for the protocol message 124 from information in the guide data message 122.

According to another example, additional and/or other information operable to be utilized as 3D video processing data for the protocol message 124 may be derived from the UTVB 132 which is transcoded at the transcoder 112. This additional/other information may derived from the transcoding process at transcoder 112 and utilized to form a protocol message 124. Transcoder 112 may then transmit protocol message 124 with a transcoded video bitstream (TVB) 134 to a mobile phone 114 operable as a client device in system 100. In addition, transcoder 112 may transmit the TVB 134 to the mobile phone 114, either separate from or combined with protocol message 124.

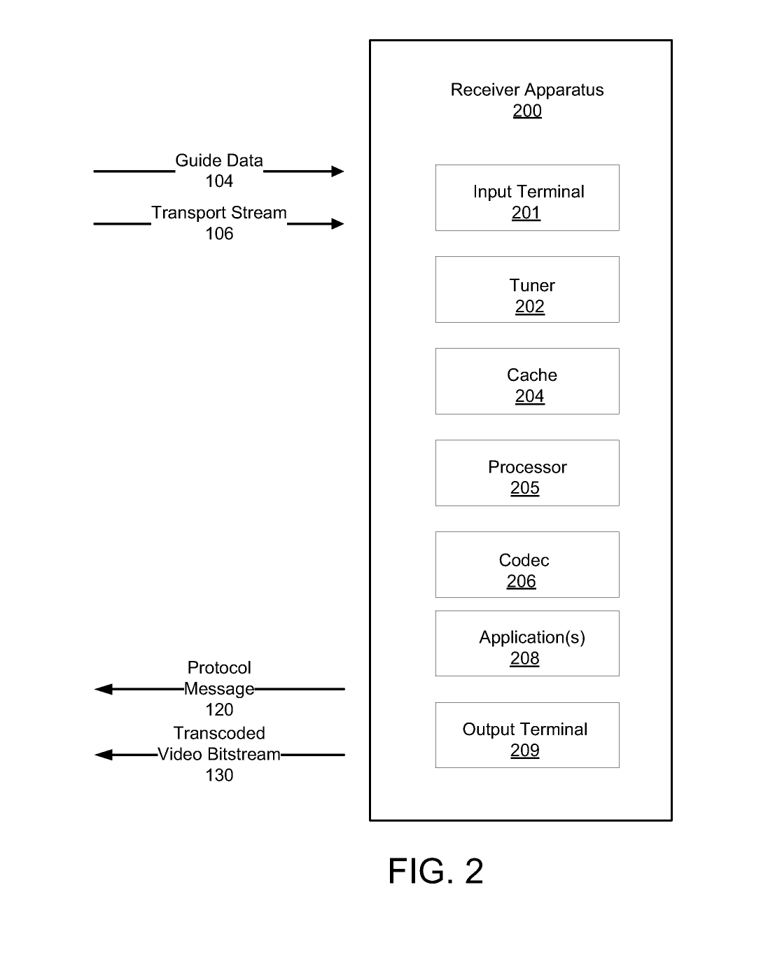

FIG. 2 demonstrates a receiver apparatus 200, according to an example. Receiver apparatus 200 may be a set top box, an integrated receiver device or some other apparatus or device operable. The receiver apparatus 200 may include an input terminal 201 to receive the transport stream 106 and the guide data 104 and/or associated metadata, according to different examples. Receiver apparatus 200 may receive the guide data 104 in a separate information stream and/or as associated metadata in the received transport stream 106 including encoded 3D video as described above with respect to FIG. 1.

Receiver apparatus 200 may include a tuner 202. According to an example, the receiver apparatus 200 may be utilized to derive associated metadata about the 3D video from the guide data 104 and/or the transport stream 106. The derived associated metadata may be stored in a cache 204 in the receiver apparatus 200. The receiver apparatus 200 may also include a processor 205 and a codec 206 which may be utilized in transcoding a first video bitstream received in the transport stream 106. Application(s) 208 are modules or programming operable in the receiver apparatus 200 to access the associated metadata stored in the cache 204. Application(s) 208 may also access associated metadata from other sources such as an integrated transcoder in the receiver apparatus 200.

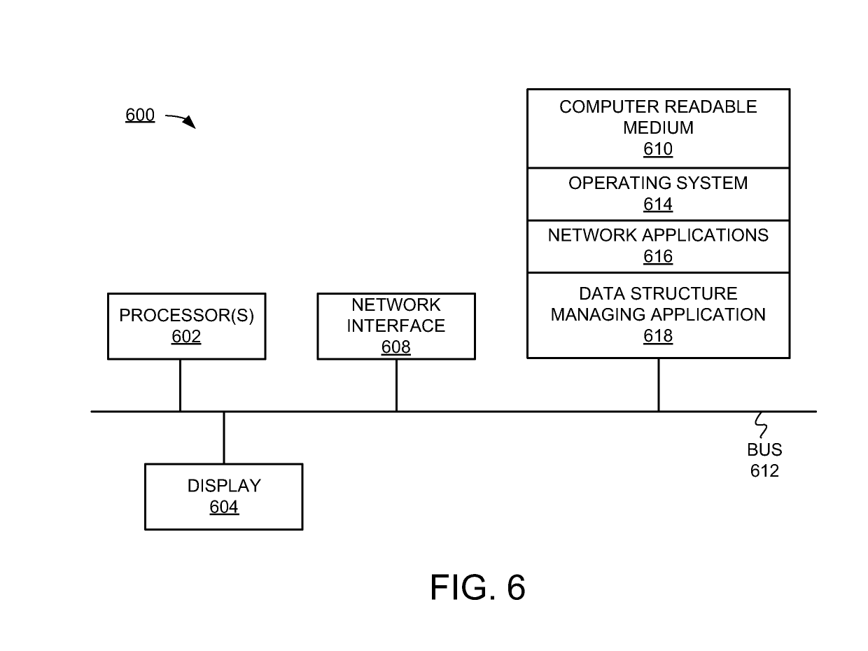

The application(s) 208 in receiver apparatus 200 may utilize the associated metadata and/or guide data 104 to form either a protocol message, such as protocol message 120, and/or a guide data message, such as guide data message 122, according to different examples. The protocol message 120 may then be transmitted or signaled with a video bitstream, such as transcoded video bitstream 130 or untranscoded video bitstream 132. These may be signaled from an output terminal 209 in the receiver apparatus to another device such as a transcoder or a client device. The guide data message 122 may be transmitted to another device, such as the transcoder 112, a second receiving apparatus, etc. wherein the transmitted guide data message 122 may be utilized in forming a protocol message. Other aspects of the receiver apparatus 200 are discussed below with respect to FIG. 6.

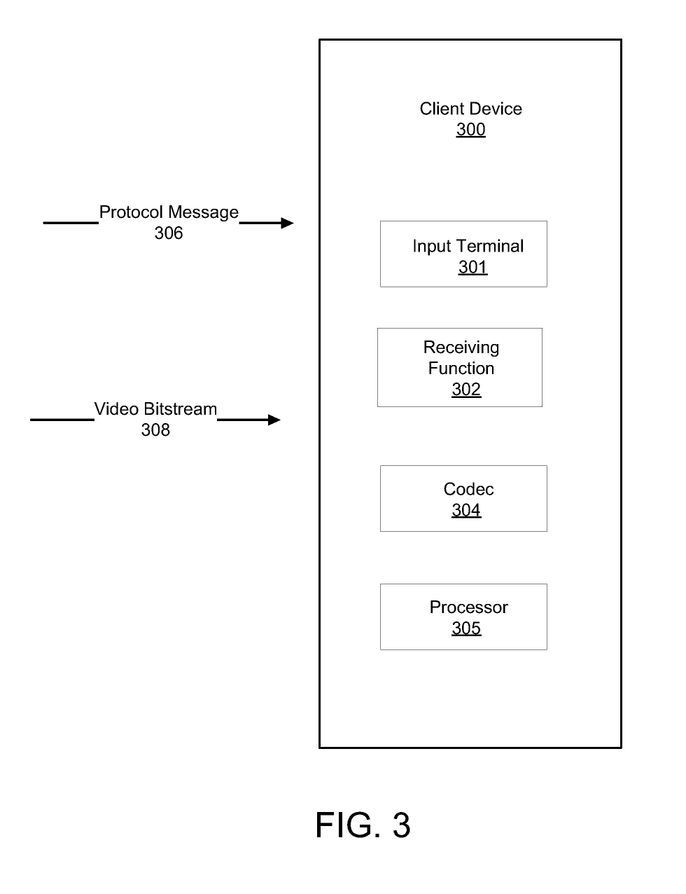

FIG. 3 demonstrates a client device 300, according to an example. Client device 300 may be a television, a computer, a mobile phone, a mobile internet device, such as a tablet computer with or without a telephone capability, or another device which receives and/or processes 3D video. Client device 300 may receive a protocol message 306 and/or a video bitstream 308 at an input terminal such as input terminal 301, the client device 300 may include a receiving function, such as receiving function 302, which may be a network based receiving function, for receiving a video bitstream with 3D video. The client device 300 may also include a codec 304 for which may be used in with a processor, such as processor 305, in decoding a received video bitstream, such as TVB 130 and TVB 134. The client device 300 may process and/or store the received protocol message 306 and the video from the video bitstream 308. Other aspects of the client device 300 are discussed below with respect to FIG. 6.

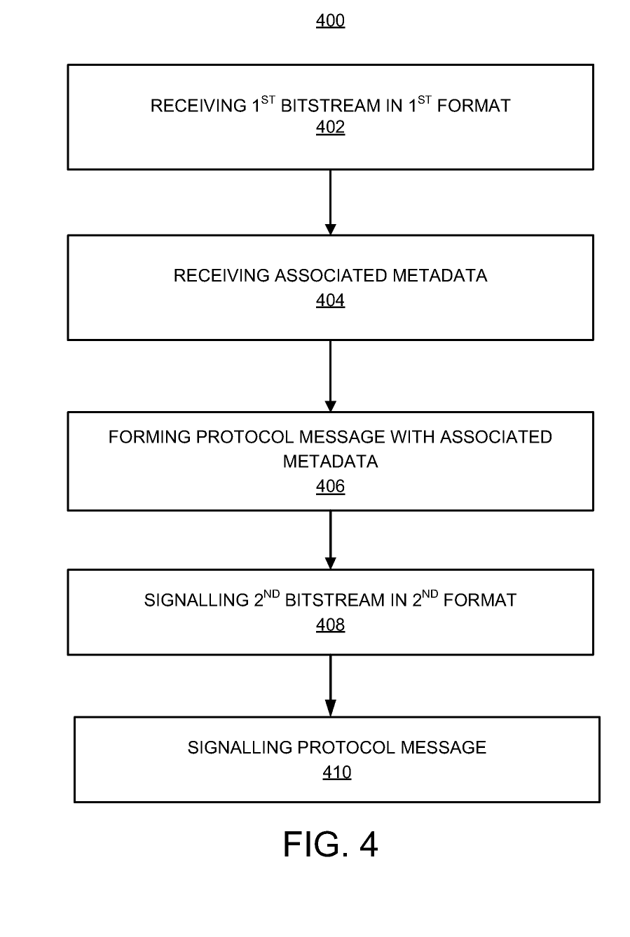

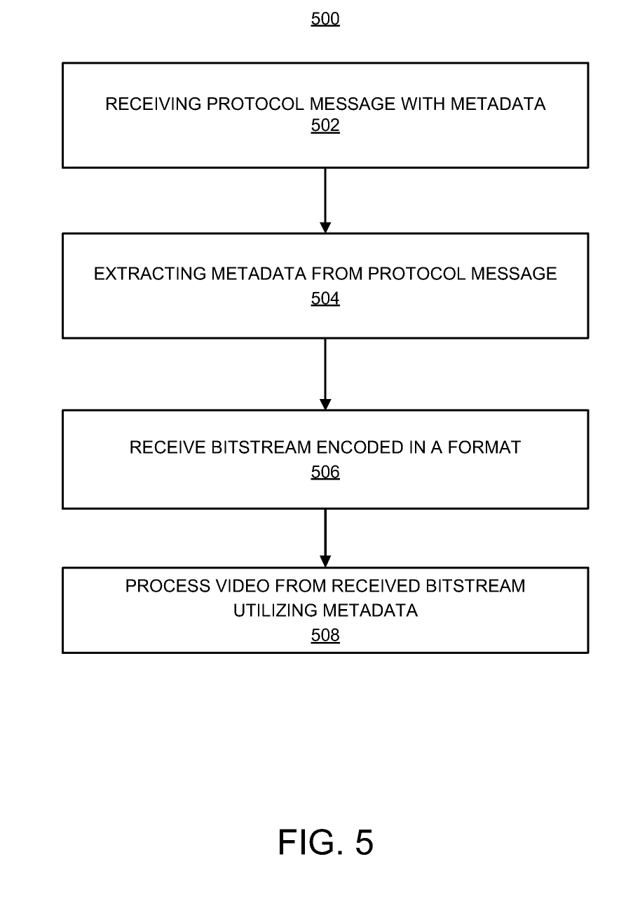

According to different examples, the receiver apparatus 200 and the client device 300 may be utilized separately or together in methods of communicating 3D video and/or processing 3D video. Various manners in which the receiver apparatus 200 and the client device 300 may be implemented are described in greater detail below with respect to FIGS. 4 and 5, which depict flow diagrams of methods 400 and 500. Method 400 is a method of communicating 3D video. Method 500 is a method of processing 3D video. It is apparent to those of ordinary skill in the art that the methods 400 and 500 represent generalized illustrations and that other blocks may be added or existing blocks may be removed, modified or rearranged without departing from the scopes of the methods 400 and 500. The descriptions of the methods 400 and 500 are made with particular reference to the receiver apparatus 200 depicted in FIG. 2 and the client device 300 depicted in FIG. 3. It should, however, be understood that the methods 400 and 500 may be implemented in apparati and/or devices which differ from the receiver apparatus 200 and the client device 300 without departing from the scopes of the methods 400 and 500.

With reference first to the method 400 in FIG. 4, at block 402, there is a receiving a first video bitstream with the 3D video encoded in a first format, utilizing the input terminal 201 in the set-top box 108, according to an example.

At block 404, there is a receiving of the associated metadata, utilizing input terminal 201 in the set-top box 108, according to an example. The associated data may be data describing or otherwise related to the 3D video in the first video bitstream.

At block 406, there is a forming a protocol message, utilizing the processor 205 in the set-top box 108, including the associated metadata. The protocol message may include data fields holding processing data, based on the associated metadata, describing the rendering of the 3D video. The processing data may be operable to be read and utilized at a client device to direct the client device to process 3D video extracted from a video bitstream received at the client device. The processing data may also be operable to present the 3D video on a display associated with the client device.

At block 408, there is a signaling of a second video bitstream with the 3D video encoded in a second format, utilizing the output terminal 209 in the set-top box 108, according to an example. Signaling may include communicating between components in a device, or between devices. The first format associated with the first video bitstream may be the same or different from the second format associated with the second video bitstream. The first and second format may be any format operable to be utilized in encoding 3D video, such as MPEG-2 and MPEG-4 AVC.

At block 410, there is a signaling of a protocol message, such as PM 120, separate from the second video bitstream, utilizing the output terminal 209 in the receiver apparatus 200, according to an example.

With reference to the method 500 in FIG. 5, at block 502, there is a receiving a protocol message 306 including the associated metadata, utilizing the input terminal 301 and/or the receiving function 302 in the client device 300, such as the television 110 or the mobile phone 114, according to different examples. The protocol message 306 may include data fields holding processing data, based on the associated metadata, describing the rendering of the 3D video. The processing data may be operable to be read and utilized at the client device 300 to direct it to process 3D video extracted from a video bitstream received at the client device. The processing data may also be operable to present the 3D video on a display associated with the client device 300.

At block 504, there is an extracting, utilizing the processor 305 in the client device 300, such as television 110 or the mobile phone 114. The processor 305 extracts the associated metadata from the received protocol message 306.

At block 506, there is a receiving, separate from the protocol message, the video bitstream 308 with the 3D video encoded in a format, utilizing the television 110 or the mobile phone 114, according to the separate examples. The encoding format may be any encoding format operable to be utilized in encoding 3D video, such as MPEG-2 and MPEG-4 AVC.

At block 508, there is a processing the 3D video from the received video bitstream utilizing the processor 305 and the associated metadata extracted from the protocol message 306, 120 or 124, according to different examples. The processing is not limited as to its function. The processing may include rendering the 3D video to present a 3D viewing mode. The processing may also include converting the 3D video to a two dimensional (2D) video. The processing may also include stretching a single view of the 3D video to occupy a larger portion of a viewing screen associated with the client device, etc. According to an example, the processing may include blocking the processing and transmitting a graphics based error message.

Some or all of the operations set forth in the figures may be contained as a utility, program, or subprogram, in any desired computer readable storage medium. In addition, the operations may be embodied by computer programs, which can exist in a variety of forms both active and inactive. For example, they may exist as a machine readable instruction set (MRIS) program comprised of program instructions in source code, object code, executable code or other formats. Any of the above may be embodied on a computer readable storage medium, which include storage devices.

An example of a computer readable storage media includes a conventional computer system RAM, ROM, EPROM, EEPROM, and magnetic or optical disks or tapes. Concrete examples of the foregoing include distribution of the programs on a CD ROM or via Internet download. It is therefore to be understood that any electronic device capable of executing the above-described functions may perform those functions enumerated above.

Turning now to FIG. 6, there is shown a computing device 600, which may be employed as a platform in a receiver apparatus, such as receiver apparatus 200 and or a client device, such as client device 300, for implementing or executing the methods depicted in FIGS. 4 and 5, or code associated with the methods. It is understood that the illustration of the computing device 600 is a generalized illustration and that the computing device 600 may include additional components and that some of the components described may be removed and/or modified without departing from a scope of the computing device 600.

The device 600 includes a processor 602, such as a central processing unit; a display device 604, such as a monitor; a network interface 608, such as a Local Area Network (LAN), a wireless 802.11x LAN, a 3G or 4G mobile WAN or a WiMax WAN; and a computer-readable medium 610. Each of these components may be operatively coupled to a bus 612. For example, the bus 612 may be an EISA, a PCI, a USB, a FireWire, a NuBus, or a PDS.

The computer readable medium 610 may be any suitable medium that participates in providing instructions to the processor 602 for execution. For example, the computer readable medium 610 may be non-volatile media, such as an optical or a magnetic disk; volatile media, such as memory; and transmission media, such as coaxial cables, copper wire, and fiber optics. Transmission media can also take the form of acoustic, light, or radio frequency waves. The computer readable medium 610 may also store other MRIS applications, including word processors, browsers, email, instant messaging, media players, and telephony MRIS.

The computer-readable medium 610 may also store an operating system 614, such as MAC OS, MS WINDOWS, UNIX, or LINUX; network applications 616; and a data structure managing application 618. The operating system 614 may be multi-user, multiprocessing, multitasking, multithreading, real-time and the like. The operating system 614 may also perform basic tasks such as recognizing input from input devices, such as a keyboard or a keypad; sending output to the display 604 and keeping track of files and directories on medium 610; controlling peripheral devices, such as disk drives, printers, image capture device; and managing traffic on the bus 612. The network applications 616 includes various components for establishing and maintaining network connections, such as MRIS for implementing communication protocols including TCP/IP, HTTP, Ethernet, USB, and FireWire.

The data structure managing application 618 provides various MRIS components for building/updating a computer readable system (CRS) architecture, for a non-volatile memory, as described above. In certain examples, some or all of the processes performed by the data structure managing application 618 may be integrated into the operating system 614. In certain examples, the processes may be at least partially implemented in digital electronic circuitry, in computer hardware, firmware, MRIS, or in any combination thereof.

The disclosure presents a solution for communicating and processing 3D video with respect to a client device. The communication and/or processing is such that the 3D video may be rendered and/or presented on a client device. The client devices may be those which otherwise could not render and/or present the 3D video, either as 3D video or as 2D video, when receiving a video bitstream with the encoded 3D video. According to the examples, the client devices do not present anomalies, such as a split screen of the two views in the 3D video, and/or other less attractive renderings of the 3D video in the video bitstream. Users of the client devices are thus provided with a satisfying experience when viewing the 3D video on the client device.

Although described specifically throughout the entirety of the disclosure, representative examples have utility over a wide range of applications, and the above discussion is not intended and should not be construed to be limiting. The terms, descriptions and figures used herein are set forth by way of illustration only and are not meant as limitations. Those skilled in the art recognize that many variations are possible within the spirit and scope of the examples. While the examples have been described with reference to examples, those skilled in the art are able to make various modifications to the described examples without departing from the scope of the examples as described in the following claims, and their equivalents.

What is claimed is:

1. A receiver apparatus communicating 3D video having associated metadata, the receiver apparatus comprising:
an input terminal configured to
receive a first video bitstream with the 3D video encoded in a first format, and
receive the associated metadata;
a processor configured to
form a protocol message, utilizing the associated metadata; and
an output terminal configured to
signal a second video bitstream with the 3D video encoded in a second format, and
signal the protocol message.

2. The receiver apparatus of claim 1, wherein the protocol message includes data fields holding processing data, based on the associated metadata, describing the rendering of the 3D video, and
wherein the processing data is operable to be read and utilized to direct a client device to process the 3D video extracted from a video bitstream and present the 3D video on a display.

3. A method of communicating 3D video having associated metadata, the method comprising:
receiving a first video bitstream with the 3D video encoded in a first format;
receiving the associated metadata;
forming a protocol message, utilizing a processor, including the associated metadata;
transmitting a second video bitstream with the 3D video encoded in a second format; and
transmitting the protocol message.

4. The method of claim 3, wherein the protocol message includes data fields holding processing data, based on the associated metadata, describing the rendering of the 3D video, and
wherein the processing data is operable to direct a client device to process the 3D video extracted from a video bitstream and present the 3D video on a display.

5. The method of claim 3, wherein the first format and the second format are the same.

6. The method of claim 3, wherein the associated metadata is received in the first video bitstream.

7. The method of claim 3, wherein the associated metadata is received separately from the first video bitstream.

8. The method of claim 7, wherein the associated metadata is received in guide data.

9. The method of claim 3, the method further comprising:
transcoding the first video bitstream encoded in the first format to form the second video bitstream encoded in the second format.

10. The method of claim 9, wherein the associated metadata is derived for the protocol message through the transcoding of the first video bitstream.

11. The method of claim 3, wherein at least one of the first and second format is according to one of MPEG-2 and MPEG-4 AVC.

12. The method of claim 3, wherein at least one of the first video bitstream and the associated metadata are received at a set top box.

13. The method of claim 3, wherein at least one of the first video bitstream and the associated metadata are received at a transcoding device.

14. A non-transitory computer readable medium (CRM) storing computer readable instructions that when executed by a computer system perform a method of communicating 3D video having associated metadata, the method comprising:
receiving a first video bitstream with the 3D video encoded in a first format;
receiving the associated metadata;
forming a protocol message, utilizing a processor, including the associated metadata;
signaling a second video bitstream with the 3D video encoded in a second format; and
signaling the protocol message.

15. The CRM of claim 14, wherein the protocol message includes data fields holding processing data, based on the associated metadata, describing the rendering of the 3D video, and
wherein the processing data is operable to direct a client device to process the 3D video extracted from a video bitstream received and present the 3D video on a display.

16. A client device to process 3D video having associated metadata, the client device comprising:
an input terminal configured to
receive a protocol message including the associated metadata, and
receive a video bitstream with the 3D video encoded in a format conforming with a definition in the received protocol message; and
a processor configured to
extract the associated metadata from the received protocol message, and
process the 3D video from the received video bitstream utilizing the associated metadata extracted from the protocol message.

17. The client device of claim 16, wherein the protocol message includes data fields holding processing data, based on the associated metadata, describing the rendering of the 3D video, and
the processor utilizes the processing data to direct the client device to process the 3D video extracted from the video bitstream received at the client device and present the 3D video on a display associated with the client device.

18. A method of processing a 3D video having associated metadata, the method comprising:
receiving a protocol message including the associated metadata;
extracting, utilizing a processor, the associated metadata from the received protocol message;
receiving a video bitstream with the 3D video encoded in a format conforming with a definition in the received protocol message; and
processing the 3D video from the received video bitstream utilizing the associated metadata extracted from the protocol message.

19. The method of claim 18, wherein the protocol message includes data fields holding processing data, based on the associated metadata, describing the rendering of the 3D video, and the method further comprises:
utilizing the data to direct a client device to process the 3D video extracted from the video bitstream and present the 3D video on a display.

20. The method of claim 18, the method further comprising:
decoding the 3D video encoded in the format, and
wherein the processing includes processing the decoded 3D video utilizing the associated metadata.

21. The method of claim 18, wherein the processing includes processing the 3D video encoded in the format utilizing the associated metadata.

22. The method of claim 18, wherein the associated metadata in the protocol message is derived for the protocol message from the video bitstream before it is received at a client device.

23. The method of claim 18, wherein the associated metadata in the protocol message is derived for the protocol message from the video bitstream before the video bitstream is received at a client device.

24. The method of claim 18, wherein the associated metadata in the protocol message is derived for the protocol message from guide data, wherein the guide data is associated with at least one of the 3D video and the associated metadata.

25. The method of claim 18, wherein the received video bitstream is transcoded from a first video bitstream in a first format to a second video bitstream in a second format before the video bitstream is received at a client device.

26. The method of claim 25, wherein the associated metadata is derived for the protocol message through the transcoding from at least one of the first and second video bitstream.

27. The method of claim 18, wherein the processing includes rendering the 3D video to present a 3D viewing mode on a viewing screen.

28. The method of claim 18, wherein the processing includes converting the 3D video to a two dimensional (2D) video.

29. The method of claim 18, wherein the processing includes stretching a single view of the 3D video to occupy a larger portion of a viewing screen.

30. The of claim 18, wherein the format of the received video bitstream is according to one of MPEG-2 and MPEG-4 AVC.

31. The method of claim 18, wherein the processing is associated with a client device which is at least one of a mobile phone and a mobile internet enabled device.

32. The method of claim 18, wherein the processing is associated with a client device which is at least one of a television and a computer.

33. A non-transitory computer readable medium (CRM) storing computer readable instructions that when executed by a computer system perform a method of processing a 3D video having associated metadata, the method comprising:
receiving a protocol message including the associated metadata;
extracting, utilizing a processor, the associated metadata from the received protocol message;
receiving a video bitstream with the 3D video encoded in a format; and
processing the 3D video from the received video bitstream utilizing the associated metadata extracted from the protocol message.

34. The CRM of claim 33, wherein the protocol message includes data fields holding processing data, based on the associated metadata, describing the rendering of the 3D video, and the method further comprises:
utilizing the processing data to direct a client device to process the 3D video extracted from the video bitstream and present the 3D video on a display.

35. The method of claim 18, wherein the processing includes displaying a graphics message indicating the 3D video is not displayed.
